(19) United States
(12) Patent Application Publication
(10) Pub. No.: US 2022/0298453 A1
(43) Pub. Date: Sep. 22, 2022

(54) Liquid Laundry Detergent Compositions Containing Soil Release Polymers

(71) Applicant: Henkel IP & Holding GmbH, Düsseldorf (DE)

(72) Inventors: Kristen Marie Higgins, Trumbull, CT (US); Jennifer Diane Coletta, West Haven, CT (US); Napaporn Komesvarakul Slattery, Monroe, CT (US)

(73) Assignee: Henkel IP & Holding GmbH, Düsseldorf (DE)

(21) Appl. No.: 17/698,369

(22) Filed: Mar. 18, 2022

Related U.S. Application Data
(60) Provisional application No. 63/162,855, filed on Mar. 18, 2021.

(51) Int. Cl. C11D 3/00; C11D 11/00; C11D 1/83; C11D 3/37; C11D 3/30; C11D 3/386; C11D 10/04

(52) U.S. Cl. CPC C11D 3/0036; C11D 11/0017; C11D 1/83; C11D 3/3715; C11D 3/3707; C11D 3/30; C11D 3/38618; C11D 3/38636; C11D 10/045; C11D 1/22

(57) ABSTRACT

Stable liquid detergent composition including about 0.25 to about 3% by weight of a polyester type soil release polymer comprising aromatic dicarboxylic acids and alkylene glycols, about 10 to about 30% by weight of an alcohol ethoxysulfate (AES) surfactant, about 1 to about 12% linear alkyl benzene sulfonate (LAS) surfactant, and about 12 to about 25% by weight of nonionic surfactant and their methods of use for washing and providing stain resistance to textiles by forming a protective barrier against stains on the textiles.

### FIELD OF THE INVENTION

This disclosure relates to liquid detergent compositions. Specifically, the disclosure relates to inclusion of soil release polymers in liquid laundry detergent compositions that impart benefits to the consumer pertaining to the washing approach, yellow-underarm stains, machine cleaning, as well as odor removal.

### BACKGROUND OF THE INVENTION

During the laundry washing cycle, soil release polymers (SRP) can be deposited onto fabric to form a protective barrier against stains. These polymers are typically most effective with polyester fabrics but can also be used with cotton or cotton/polyester blends.

However, depending on how a laundry detergent composition is formulated and wash conditions, SRP may not be effectively deposited onto fabric to form a protective barrier. Conventionally, it may take several washes (for example, up to 10 washes) for the protective barrier to form and become efficacious. Prior to the formation of this barrier, the consumer will see minimal to no benefits. Without the protective barrier, a stain is adhered directly to the textile fabric, resulting in a more difficult stain to clean. In contrast, after an efficacious protective barrier is formed by SRP and the textile is stained (especially with oily stains such as beef drippings, sebum, oily makeup, butter), cleaning surfactants can more readily remove the stain by dislodging the SRP protective barrier that the stain is adhered to.

There is no industrial recommendation as to how many pre-washes are required to obtain optimal benefit of a SRP; however, it is understood that there is a minimal number of pre-washes needed to form an efficacious barrier before the benefit becomes stagnant. There are many factors that play a role in the minimum number of pre-washes, such as type of polymer, level of active delivery per wash, type of fabric, and type of stain. As a result, it is recommended that consumers pre-wash clothes multiple times before use to form an SRP protective barrier prior to wearing a garment.

However, performing multiple prewashes to form an SRP barrier is a burden to consumers. There is a long-felt industry need for a product formulation that reduces or eliminates pre-washes as a necessary step in forming a SRP barrier, i.e., forming a SRP barrier through normal washes instead of pre-washes, with fewer washes needed to form the SRP barrier. Any reduction in the number of washes to form an efficacious SRP barrier would improve the consumer experience with this class of polymers. Moreover, reducing or removing a need for pre-washing clothing to obtain the benefits of an SRP would also be an environmental benefit.

It is an object of the invention to provide liquid detergent compositions containing SRP that are able to reduce the number of pre-washes needed to form an SRP protective barrier.

WO 2012/104159 discloses that certain commercially available polyester SRPs are unsuitable for use in alkaline laundry liquids due to hydrolysis, and that their hydrolysis is made even worse when the formula contains triethanolamine (TEA). The application proposes synthesis of alternative SRP compounds for use in alkaline detergent compositions and use of high levels of propylene glycol (15-20 wt. %).

WO 2018/028935 discloses that stable heavy duty liquid detergent (HDL) incorporating commercial polyester SRPs can be made if precise amounts of synthetic surfactant and propylene glycol are used. No data is provided on wash performance or ability of the composition to form an SRP protective barrier.

There is a desire to incorporate commercially available polyester SRPs into existing detergent chassis formulations that are rich in nonionic and AES surfactants and that also contain triethanolamine. Thus, it is an object of the invention to provide alternative detergent compositions comprising polyester based SRFs.

Moreover, there is an increasing desire to use ingredients in liquid detergents that are bio-based as opposed to synthetically sourced. It is thus an object of the invention to provide stable alternative liquid detergent composition comprising bio-based polyester SRPs, such as those having an 80% Renewable Carbon Index (RCI). In particular, it is an object of the invention to incorporate bio-based polyester SRPs into existing detergent chasses that are rich in nonionic and AES surfactants and that also contain triethanolamine. It is desired that such compositions have equivalent or improved stain removal performance compared to synthetic polyester based SRPs.

### SUMMARY OF THE INVENTION

The foregoing is achieved by provision of compositions and methods for reducing the number of pre-washes needed to form an SRP protective barrier. Novel formulas are provided which allow the formation of an efficacious SRP barrier with minimal washes (e.g., as few as just one wash). As such, the novel formulas in accordance with the present invention remove the need of pre-washing clothing, which provides an additional environmental benefit. Studies show that as a result of building the SRP barrier, the cleaning effect improves significantly in even just after a single wash (i.e., the first wash). The SRP barrier improves with additional washes. In some embodiments, the SRP barrier reaches its peak (optimal stage) with as few as three washes.

In one aspect, the invention provides a stable liquid detergent composition comprising about 0.25 to about 3% by weight of a polyester type soil release polymer comprising aromatic dicarboxylic acids and alkylene glycols, about 10 to about 30% by weight of an alcohol ethoxysulfate (AES) surfactant, about 1 to about 12% linear alkyl benzene sulfonate (LAS) surfactant, and about 10 to about 25%, preferably about 12 to about 25%, more preferably, about 15 to about 25% by weight of nonionic surfactant.

In certain embodiments, the detergent composition comprises less than 2.5% by weight polyethylene glycol, more preferably less than 1.0% by weight, most preferably less than 0.5% by weight.

In some embodiments, the linear alkyl benzene sulfonate surfactant is sodium dodecylbenzene sulfonate.

In certain embodiments, the composition contains 12-25% by weight, preferably about 15% by weight of the nonionic surfactant. In some embodiments, the nonionic surfactant is an alkyl ether.

In certain embodiments the SRP has (a) one or more nonionic hydrophilic components consisting essentially of (i) polyoxyethylene segments having a polymerization level of at least 2 or (ii) oxypropylene or polyoxypropylene segments having a polymerization level of 2 to 10, where the hydrophilic segment does not include any oxypropylene units, except when they are bonded via ether bonds to adjacent moieties at each end, or (iii) a mixture of oxyalkylene units comprising oxyethylene units and 1 to about 30 oxypropylene units. In certain of those embodiments, the polyoxyethylene segments of (a)(i) have a polymerization level of about 1 to about 200. In other embodiments, the SRP has (b) one or more hydrophobic components comprising (i) C3-oxyalkylene terephthalate segments where, when hydrophobic components also include oxyethylene terephthalate, a ratio of oxyethylene terephthalate to C3-oxyalkylene terephthalate units is about 2:1 or less, (ii) C4-C6-alkylene or oxy-C4-C6-alkylene segments or mixtures thereof, (iii) polyvinyl ester) segments, or (iv) C1-C4-alkyl ether or C4-hydroxyalkyl ether substituents or mixtures thereof, where the substituents are C1-C4-alkyl ether or C4-hydroxyalkyl ether cellulose derivatives or mixtures thereof and the cellulose derivatives are amphiphilic. In certain embodiments, the SRP is a combination of (a) and (b) type polymers. In certain preferred embodiments, the SRP is or comprises a polyester having repeat units formed from alkylene terephthalate units, containing 10%-30% by weight of alkylene terephthalate units together with 90%-70% by weight of polyoxyethylene terephthalate units which derive from a polyoxyethylene glycol having a mean molecular weight of 300-8000. In some preferred embodiments, the SRP is bio-based, e.g. derived from a plant or other biological material.

In some embodiments, the detergent composition further comprises about 0.5 to about 3.5% by weight of a fatty acid soap. In some of those embodiments, the said fatty acid soap is selected from the group consisting of sodium salts of saturated C₁₄-C₁₈ carboxylic acids, sodium salts of unsaturated C₁₄-C₁₈ carboxylic acids, potassium salts of saturated C₁₄-C₁₈ carboxylic acids, potassium salts of unsaturated C₁₄-C₁₈ carboxylic acids, and mixtures thereof. Preferably, the fatty acid soap is coconut oil fatty acid.

In certain embodiments, the detergent composition further comprises at least one or more other substances selected from the group consisting of pH adjusting agents, perfumes, fluorescing agents (optical brighteners), dyes, and colorants. In certain of those embodiments, the composition comprises triethanolamine.

In some embodiments, the detergent composition further comprises at least one enzyme selected from the group consisting of proteases, amylases, lipases, cellulases, mannanases, pectinases and combinations thereof. The enzyme(s) preferably comprises 0.1 to 5 wt.-%, more preferably 0.5 to 3 wt.-%, relative to the total weight of the composition. In some of those embodiments, the enzyme comprises (i) at least one protease in an amount of 0.01 to 0.3 wt. % relative to the total weight of the composition; (ii) at least one amylase in an amount of 0.2 to 1.0 wt. % relative to the total weight of the composition; and (iii) at least one mannanase in an amount of 0.2 to 1.0 wt. % relative to the total weight of the composition.

In a particularly preferred aspect, the invention provides a liquid detergent composition comprising about 0.5 to about 1.5% by weight of a polyester soil releasing polymer having repeat units formed from alkylene terephthalate units, containing 10%-30% by weight of alkylene terephthalate units together with 90%-70% by weight of polyoxyethylene terephthalate units which derive from a polyoxyethylene glycol having a mean molecular weight of 300-8000, about 10 to about 30% by weight of an alcohol ethoxysulfate (AES) surfactant, about 1 to about 12% linear alkyl benzene sulfonate (LAS) surfactant, and about 10 to about 25% by weight of an alcohol ethoxylate nonionic surfactant.

The invention also provides a method for cleaning textiles comprising contacting textiles with a washing liquor containing the detergent compositions disclosed herein in at least one step of a washing process. The cleaning can occur when the washing liquor is about 80° F. or less than 80° F. Advantageously, the cleaning can occur in cold water when the washing liquor is less than 60° F. The method effectively removes yellow-underarm stains, other common stains, as well as has odor removal abilities

A method for preventing redeposition of dirt during washing of textiles is also provided comprising contacting textiles with a washing liquor containing the detergent compositions disclosed herein in at least one step of a washing process. The method can occur when the washing liquor is about 80° F. or less than 80° F. Advantageously, the cleaning can occur in cold water when the washing liquor is less than 60° F.

In a further aspect, the present disclosure provides an efficacious method of cleaning a laundry machine by laundering textiles in the machine with a composition described herein.

### BRIEF DESCRIPTION OF THE DRAWINGS

The accompanying drawings illustrate various examples of the principles described herein and are a part of the specification. The illustrated examples do not limit the scope of the claims.

FIG. 1 is graph showing the stain removal performance a composition described herein as compared to a formula without soil release polymer after various number of washes. The stain was RAGU® sauce on polyester fabric washed at 90° F.

FIG. 2 is a graph showing the stain removal performance of a composition described herein as compared to a formula without soil release polymer after various number of washes, The stain was beef drippings on polyester fabric washed at 90° F.

### DETAILED DESCRIPTION OF THE INVENTION

The following description provides specific details, such as materials and amounts, to provide a thorough understanding of the present invention. The skilled artisan, however, will appreciate that the present invention can be practiced without employing these specific details, Indeed, the present invention can be practiced in conjunction with processing, manufacturing or fabricating techniques conventionally used in the detergent composition industry.

Absent explicit statement to the contrary, reference to wt. %, or wt. %, or percent by weight, in the specification refers to the weight percentage of an ingredient as compared to the total weight of the detergent composition. Accordingly, the calculation of wt. % for a detergent composition or an ingredient thereof does not include, for example, the weight of the film. For example, the wt. % of sodium lauryl ether sulfate (SLES) refers to the weight percentage of the active SLES in the composition. The wt. % of the total water in the liquid composition is calculated based on all the water including those added as a part of individual ingredients. When an ingredient added to make the liquid composition is not 100% pure and used as a mixture, e.g., in a form of a solution, the wt. % of that material added refers to the weight percentage of the mixture. Thus, a component which is 5 wt. % of the formulation, may be added as 5 wt. % of a pure component or 10 wt. % of solution that is 50% component and 50% water. Either result produces the recited 5 wt. % amount of the component in the resulting formulation. All percentages presented in this specification and the associated claims are weight percentages unless explicitly identified otherwise. If not indicated otherwise, all percentages refer to active matter and are by weight relative to the total weight of the composition,

Mole fractions and volume fractions are not used unless explicitly identified.

“At least one”, as used herein, relates to one or more, i.e. 1, 2, 3, 4, 5, 6, 7, 8, 9, or more. If used in combination with a compound, the term does not relate to the absolute number of molecules but rather to the number of different types of said compound. “At least one surfactant” thus means that at least one type but that also 2 or more different surfactant types can be present.

“About”, as used herein in relation to a numerical value, relates to said value ±10%, preferably ±5%. “About 2,0” thus refers to a range from 1.8 to 2.2, preferably from 1.9 to 2.1.

As used in this specification and the associated claims, organic molecules may be represented using the notation of the letter C followed by a number, e.g., C12. The number indicates the number of carbon atoms in the associated organic molecule. The identified organic molecules need not be hydrocarbons but may include substitutions, for example, C3 polyols would include both glycerin and propylene glycol, both of which have three carbons in their structure and multiple hydroxyl substitutions.

The detergent composition described exists as a liquid. The detergent composition is formulated to be shelf stable, for example, not to undergo unexpected and/or determination changes during shipping, storage, etc. prior to use. In some embodiments, the detergent composition is substantially free of solids. The detergent composition may be substantially free of precipitates. The detergent composition may remain free of precipitates and/or other solids during storage and/or environmental testing conditions to simulate storage.

“Free of”, as used herein in relation to a specific type of component, means that the referenced composition does not contain more than 0.5 wt. %, preferably no more than 0.1 wt. %, more preferably no more than 0.05 wt. % of said component relative to the total weight of the composition. Most preferably, said component is not contained at all.

The detergent compositions of the present invention can be used as detergents for textiles, carpets or natural fibers or fabric conditioners. In preferred embodiments, the detergents disclosed herein are heavy duty liquid (HDL) detergents.

In various embodiments, the liquid detergent may be an aqueous liquid detergent and contain water, typically in substantial amounts, such as up to 40 wt. %, preferably 10 to 30 wt. %. The compositions disclosed herein can be provided in a higher compacted form compared to established compositions and thus less amount of liquid detergent is needed for the same washing performance. The liquid detergent may be a phosphate-free detergent and/or may be a structured liquid detergent.

The detergent composition disperses into the wash liquid. The dilution from the detergent composition to the concentration in the wash liquid may be substantial, for example, over multiple orders of magnitude. Accordingly, the detergent composition is stable in its concentrated composition and at its dilute composition.

### Soil Release Polymers

Suitable soil release polymers may include those disclosed in U.S. Publication No. 20190330565, the entirety of which is incorporated by reference.

Suitable soil release polymers include polyester-based soil release polymers, which generally comprise polymers of aromatic dicarboxylic acids and alkylene glycols (including polymers that additionally contain polyalkylene glycols). The polymeric soil release agents usable here especially include those soil release agents having

(a) one or more nonionic hydrophilic components consisting essentially of (i) polyoxyethylene segments having a polymerization level of at least 2 or (ii) oxypropylene or polyoxypropylene segments having a polymerization level of 2 to 10, where the hydrophilic segment does not include any oxypropylene units, except when they are bonded via ether bonds to adjacent moieties at each end, or (iii) a mixture of oxyalkylene units comprising oxyethylene units and 1 to about 30 oxypropylene units, where the mixture contains a sufficiently great amount of oxyethylene units for the hydrophilic component to be hydrophilic enough to increase the hydrophilicity of conventional synthetic polyester fiber surfaces on deposition of the soil release agent on such a surface, where the hydrophilic segments contain preferably at least 25% oxyethylene units and more preferably, especially for those components having about 20 to 30 oxypropylene units, at least about 50% oxyethylene units;

or

(b) one or more hydrophobic components comprising: (i) C3-oxyalkylene terephthalate segments where, when the hydrophobic components also include oxyethylene terephthalate, the ratio of oxyethylene terephthalate to C3-oxyalkylene terephthalate units is about 2:1 or less, (ii) C4-C6-alkylene or oxy-C4-C6-alkylene segments or mixtures thereof, (iii) polyvinyl ester) segments, preferably polyvinyl acetate, with a polymerization level of at least 2 or (iv) C1-C4-alkyl ether or C4-hydroxyalkyl ether substituents or mixtures thereof, where the substituents are in the form of C1-C4-alkyl ether or C4-hydroxyalkyl ether cellulose derivatives or mixtures thereof and cellulose derivatives of this kind are amphiphilic, where they have a sufficient content of C1-C4-alkyl ether and/or C4-hydroxyalkyl ether units to be deposited on conventional synthetic polyester fiber surfaces and, after adhering on a conventional synthetic fiber surface of this kind, retain a sufficient content of hydroxyl groups to increase the hydrophilicity of the fiber surface,

or

a combination of (a) and (b).

Typically, the polyoxyethylene segments of (a)(i) have a polymerization level of about 1 to about 200, although it is also possible to use higher levels, preferably of 3 to about 150 and more preferably of 6 to about 100.

A preferred polymeric soil release agent is a polyester having repeat units formed from alkylene terephthalate units, containing 10%-30% by weight of alkylene terephthalate units together with 90%-70% by weight of polyoxyethylene terephthalate units which derive from a polyoxyethylene glycol having a mean molecular weight of 300-8000.

In one embodiment, the SRP is a (1) polyester polymer based on terephthalic acid and propylene glycol with a molecular weight of less than 4000 g/mol. In some of those embodiments, the polyester polymers are polyesters based on terephthalic acid and 1,2-propylene glycol endcapped with methoxy PEG 750 and a molecular weight of about 2700 g/mol.

In another embodiment, the SRP is a (2) polyester polymer based on terephthalic acid and propylene glycol with a molecular weight of equal to or more than 4000 g/mol. In some of those embodiments, the polyester polymers are polyesters based on terephthalic acid and 1,2-propylene glycol endcapped with methoxy PEG 2000 and a molecular weight M w of about 6200 g/mol.

In another embodiment, the SRP is (3) a polymer obtainable by radical copolymerisation of at least one monomer of formula (I) with at least one monomer of formula (II):

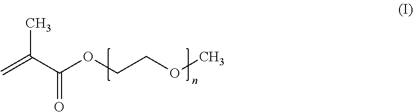

in which n is a number equal to or larger than 3, preferably a number in the range of from 3 to 120, more preferred a number in the range of from 5 to 50 and most preferred a number in the range of from 7 to 46, and in embodiments of the invention n is selected from the group encompassing the numbers 7, 23, and 46,

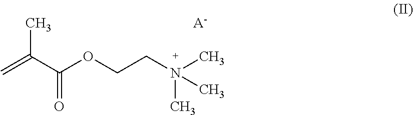

in which A′ is an anion, preferably selected from the group encompassing halides, such as fluoride, chloride, bromide, iodide, sulfate, hydrogensulfate, alkylsulfate, such as methylsulfate, and their mixtures, in wt. % relative to the total weight of the composition. In some of those embodiments, a part of units stemming from monomers according to formula (II) are replaced by units stemming from the not quaternized monomer according to formula (IIa)

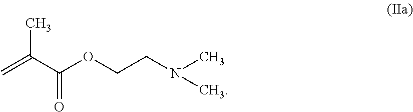

In some of those embodiments, not more than 60 mol% of monomers of SRP (3) are units from monomers according to formula (II).

In certain embodiments, the SRP is a combination of (1) to (3).

Typically, the detergent composition contains about 0.25 wt. % to about 3.5 wt. % of soil release polymer, preferably about 0.5 wt. % to about 3 wt. %, more preferably about 0.5 to about 1 wt. % active SRP.

Examples of particularly useful soil release polymers are commercially available water-soluble polyester substances which are provided as an aqueous mixture or in a mixture with 10-20% w/w propylene glycol (TexCare® SRN 170 and TexCare® SRN 260 from Clariant). See also U.S. Pat. No. 4,702,857. In particularly preferred embodiments, the SRP is bio-based, e.g. derived from a plant or other biological material.

### Surfactant

Surfactants useful in the liquid compositions of the present invention include, for example, one or more anionic surfactants, a nonionic surfactant, a cationic surfactant, an ampholytic surfactant, a zwitterionic surfactant, and/or mixtures thereof. The use of multiple surfactants of a particular type or a distribution of different weights of a surfactant may be particularly useful. The categories of surfactants will be discussed individually, below.

The detergent compositions of the invention comprise non-soap surfactant of the anionic and of the nonionic type. Said anionic surfactant is comprised of at least one, preferably at least two different anionic surfactants.

Anionic Surfactants: suitable anionic surfactants include, but are not limited to, those surfactants that contain a long chain hydrocarbon hydrophobic group in their molecular structure and a hydrophilic group, i.e., water solubilizing group including salts such as carboxylate, sulfonate, sulfate, or phosphate groups. Suitable anionic surfactant salts include sodium, potassium, calcium, magnesium, barium, iron, ammonium and amine salts.

The detergent compositions include an alkyl ether sulfate also referred to alcohol ethoxy sulfates (AES). The alkyl-ether sulfates will generally be used in the form of mixtures comprising varying R′ chain lengths and varying degrees of ethoxylation. The heterogeneity of chain length may be due to the sourcing of the material and/or the processing of the material. Frequently such mixtures will inevitably also contain some unethoxylated alkyl sulfate materials, i.e., surfactants of the above ethoxylated alkyl sulfate formula wherein n=0. Unethoxylated alkyl sulfates may also be added separately to the liquid compositions of this invention. Suitable unalkoxylated, e.g., unethoxylated, alkyl-ether sulfate surfactants are those produced by the sulfation of higher C₈-C₂₀fatty alcohols. Conventional primary alkyl sulfate surfactants have the general formula of: ROSO₃M, wherein R is typically a linear C₈-C₂₀hydrocarbyl group, which may be straight chain or branched chain, and M is a water-solubilizing cation; preferably R is a C₁₀-C₁₅ alkyl, and M is alkali metal. In one embodiment, R is C₁₂-C₁₄ and M is sodium.

In one embodiment, the AES corresponds to the following formula (Ill):

R′—O—(C₂H₄O)ₙ—SO₃M′ (III)

wherein R′ is a C₈-C₂₀ alkyl group, n is from 1 to 20, and NV is a salt-forming cation; preferably, R′ is C₁₀-C₁₈ alkyl, n is from 1 to 15, and M′ is sodium, potassium, ammonium, alkylammonium, or alkanolammonium. In an embodiment, R′ is a C₁₂-C₁₆ alkyl, n is from 1 to 6 and M′ is sodium. In one preferred embodiment, the alkyl-ether sulfate has a C₁₂ alkyl chain, for example, sodium lauryl ether sulphate (SLES).

In one embodiment, the detergent composition contains at least 10 wt. % AES surfactant, preferably about 10 wt. % to about 40 wt. %, more preferably about 10 wt. % to about 24 wt. %, or about 12 to about 20 wt. %.

The anionic surfactant may include a water-soluble salt of an alkyl benzene sulfonate having between 8 and 22 carbon atoms in the alkyl group. In one embodiment, the anionic surfactant comprises an alkali metal salt of C10-16 alkyl benzene sulfonic acids, such as C₁₁₋₁₄ alkyl benzene sulfonic acids. In one embodiment, the alkyl group is linear and such linear alkyl benzene sulfonates are known in the art as “LAS.” An exemplary LAS is 2-phenyl sulfonic acid, also referred to as 2-dodecylbenzenesulfonic acid.

In certain embodiments, LAS may be present in the liquid detergent composition at about 0.5 to about 15 wt. % of the detergent composition, more preferably about 1 to about 12 wt. % or about 1 to about 8 wt. %, most preferably about 4 to about 8 wt. %. In certain preferred embodiments, LAS, namely 2-dodecylbenzenesulfonic acid, is present in the detergent composition at about 4 wt. %.

Other suitable anionic surfactants include sodium and potassium linear, straight chain alkylbenzene sulfonates in which the average number of carbon atoms in the alkyl group is between 11 and 14. Sodium C₁₄-C₁₄, e.g., C₁₂, LAS are exemplary of suitable anionic surfactants for use herein.

In one embodiment, the anionic surfactant includes at least one α-sulfofatty acid ester. Such a sulfofatty add is typically formed by esterifying a carboxylic add with an alkanol and then sulfonating the a-position of the resulting ester. The a-sulfofatty add ester is typically of the following formula (IV):

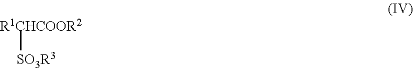

wherein R¹ is a linear or branched alkyl, R² is a linear or branched alkyl, and R³ is hydrogen, a halogen, a mono-valent or di-valent cation, or an unsubstituted or substituted ammonium cation. R¹ can be a C₄ to C₂₄ alkyl, including a C₁₀, C₁₂, C₁₄, C₁₆ and/or C₁₈ alkyl. R² can be a C₁ to C₈ alkyl, including a methyl group. R³ is typically a mono-valent or di-valent cation, such as a cation that forms a water soluble salt with the a-sulfofatty acid ester (e.g., an alkali metal salt such as sodium, potassium or lithium). The ca-sulfofatty acid ester of formula (II) can be a methyl ester sulfonate, such as a C₁₆ methyl ester sulfonate, a C₁₈ methyl ester sulfonate, or a mixture thereof. In another embodiment, the α-sulfofatty acid ester of formula (II) can be a methyl ester sulfonate, such as a mixture of C₁₂-C₁₈ methyl ester sulfonates.

More typically, the α-sulfofatty acid ester is a salt, such as a salt according to the following formula (V):

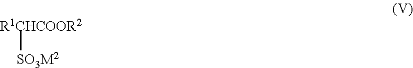

wherein R¹ and R² are linear or branched alkyls and M² is a monovalent metal. R¹ can be a C₄ to C₂₄alkyl, including a C₁₀, C₁₂, C₁₄, C₁₆, and/or C₁₈ alkyl. R² can be a C₁ to C₈ alkyl, including a methyl group, M² is typically an alkali metal, such as sodium or potassium. The α-sulfofatty acid ester of formula (III) can be a sodium methyl ester sulfonate, such as a sodium C₈-C₁₈ methyl ester sulfonate.

In one embodiment, the detergent composition contains about 10 wt. % to about 50 wt. % of one or more anionic surfactants, preferably about 10 wt. % to about 40 wt. % , more preferably about 10 wt. % to about 30 wt. %, even more preferably about 12 wt. % to about 25 wt. % or about 12 wt. % to about 15 wt. %. In some embodiments, the anionic surfactant is provided in a solvent.

Suitable nonionic surfactants include but not limited to alkoxylated fatty alcohols, ethylene oxide (EO)-propylene oxide (PO) block polymers, and amine oxide surfactants. Suitable for use in the liquid compositions herein are those nonionic surfactants which are normally liquid. Suitable nonionic surfactants for use herein include the alcohol alkoxylated nonionic surfactants. Alcohol alkoxylates are materials which correspond to the general formula of: R⁹(CₘH₂ₘO)ₙOH, wherein R⁹ is a linear or branched C_{B}-Cis alkyl group, m is from 2 to 4, and n ranges from 2 to 12: alternatively R⁹ is a linear or branched C₉₋₁₅ or C₁₀₋₁₄ alkyl group. In another embodiment, the alkoxylated fatty alcohols will be ethoxylated materials that contain from 2 to 12, or 3 to 10, ethylene oxide (EO) moieties per molecule. The alkoxylated fatty alcohol materials useful in the liquid compositions herein will frequently have a hydrophilic-lipophilic balance (HLB) which ranges from 3 to 17, from 6 to 15, or from 8 to 15. Another nonionic surfactant suitable for use includes ethylene oxide (EO)-propylene oxide (PO) block polymers. These materials are formed by adding blocks of ethylene oxide moieties to the ends of polypropylene glycol chains to adjust the surface active properties of the resulting block polymers. In one embodiment, the nonionic surfactant is C₁₂-C₁₅ alcohol ethoxylate 7EO, that is to say having seven ethylene oxide moieties per molecule. The fatty alcohol ethoxylate may have 3 to 17 moles of ethylene oxide units per mole of fatty alcohol ethoxylate.

Another embodiment of a nonionic surfactant is alkoxylated, preferably ethoxylated or ethoxylated and propoxylated fatty acid alkyl esters, having from 1 to 4 carbon atoms in the alkyl chain, especially fatty acid methyl esters, as described, for example, in JP58/217598, which is incorporated by reference herein. In one embodiment, the nonionic surfactant is methyl ester ethoxylate.

Suitable nonionic surfactants also include polyalkoxylated alkanolamides, which are generally of the following formula (VI):

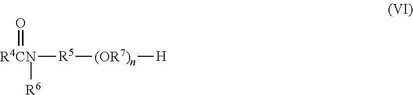

wherein R⁴ is an alkyl or alkoxy, R⁵ and R⁷ are alkyls and n is a positive integer. R⁴ is typically an alkyl containing 6 to 22 carbon atoms. R⁵ is typically an alkyl containing 1-8 carbon atoms. R⁷ is typically an alkyl containing 1 to 4 carbon atoms, and more typically an ethyl group. The degree of polyalkoxylation (the molar ratio of the oxyalkyl groups per mole of alkanolamide) typically ranges from about 1 to about 100, or from about 3 to about 8, or about 5 to about 6. R⁶ can be hydrogen, an alkyl, an alkoxy group or a polyalkoxylated alkyl. The polyalkoxylated alkanolamide is typically a polyalkoxylated mono- or di-alkanolamide, such as a C₁₆ and/or C₁₈ ethoxylated monoalkanolamide, or an ethoxylated monoalkanolamide prepared from palm kernel oil or coconut oil. The use of coconut oil, palm oil, and similar naturally occurring oils as precursors may be favored by consumers.

Other suitable nonionic surfactants include those containing an organic hydrophobic group and a hydrophilic group that is a reaction product of a solubilizing group (such as a carboxylate, hydroxyl, amide or amino group) with an alkylating agent, such as ethylene oxide, propylene oxide, or a polyhydration product thereof (such as polyethylene glycol). Such nonionic surfactants include, for example, polyoxyalkylene alkyl ethers, polyoxyalkylene alkylphenyl ethers, polyoxyalkylene sorbitan fatty acid esters, polyoxyalkylene sorbitol fatty acid esters, polyalkylene glycol fatty acid esters, alkyl polyalkylene glycol fatty acid esters, polyoxyethylene polyoxypropylene alkyl ethers, polyoxyalkylene castor oils, polyoxyalkylene alkylamines, glycerol fatty acid esters, alkylglucosamides, alkylglucosides, and alkylarnine oxides. Other suitable surfactants include those disclosed in U.S. Pat. Nos. 5,945,394 and 6,046,149, the disclosures of which are incorporated herein by reference. In another embodiment, the composition is substantially free of nonylphenol nonionic surfactants. In this context, the term “substantially free” means less than about one weight percent.

Yet another nonionic surfactant useful herein comprises amine oxide surfactants. Amine oxides are often referred to in the art as “semi-polar” nonionics, and have the following formula (VII):

R¹⁰(EO)ₓ(PO)_{y}(BO)_{z}N(O)(CH₂R¹¹)₂.qH₂O (VII)

wherein R¹⁰ is a hydrocarbyl moiety which can be saturated or unsaturated, linear or branched, and can typically contain from 8 to 24, from 10 to 16 carbon atoms, or a C12-C16 primary alkyl. R¹¹ is a short-chain moiety such as a hydrogen, methyl and —CH₂OH. When x+y+z is greater than 0, EO is ethyleneoxy, PO is propyleneoxy and BO is butyleneoxy. In this formula, q is the number of water molecules in the surfactant. In one embodiment, the nonionic surfactant is C₂₋₁₄ alkyldimethyl amine oxide.

In one embodiment, the detergent composition includes about 5 wt. % to about 40 wt. % of one or more nonionic surfactants, preferably about 10 wt. % to about 25 wt. %, more preferably about 12 wt. % to about 20 wt. %.

Zwitterionic and/or Amphoteric Surfactants: Suitable zwitterionic and/or amphoteric surfactants include but not limited to derivatives of secondary and tertiary amines, derivatives of heterocyclic secondary and tertiary amines, or derivatives of quaternary ammonium, quaternary phosphonium or tertiary sulfoniurn compounds, such as those disclosed in U.S. Pat. No. 3,929,678, which is incorporated by reference herein.

Suitable zwitterionic and/or amphoteric surfactants for uses herein include amido propyl betaines and derivatives of aliphatic or heterocyclic secondary and ternary amines in which the aliphatic moiety can be straight chain or branched and wherein one of the aliphatic substituents contains from 8 to 24 carbon atoms and at least one aliphatic substituent contains an anionic water-solubilizing group. When present, zwitterionic and/or amphoteric surfactants typically constitute from 0.01 wt. % to 20 wt. %, preferably, from 0.5 wt. 9/0 to 10 wt. %, and most preferably 2 wt. % to 5 wt. % of the formulation by weight.

Cationic Surfactants: Suitable cationic surfactants include but not limited to quaternary ammonium surfactants. Suitable quaternary ammonium surfactants include mono C₆-C₁₆, or C₆-C₁₀ N-alkyl or alkenyl ammonium surfactants, wherein the remaining N positions are substituted by, e.g., methyl, hydroxyethyl or hydroxypropyl groups. Another cationic surfactant is C₆-C₁₈ alkyl or alkenyl ester of a quaternary ammonium alcohol, such as quaternary chlorine esters. In another embodiment, the cationic surfactants have the following formula (VIII):

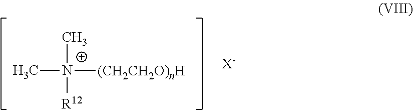

wherein R¹² is C₈-C₁₈ hydrocarbyl and mixtures thereof, or C₈₋₁₄ alkyl, or C₈, C₁₀, or C₁₂ alkyl, X is an anion such as chloride or bromide, and n is a positive integer.

(0069) The surfactants may be a mixture of at least one anionic and at least one nonionic surfactant. In another embodiment, the anionic surfactant is sodium lauryl ether sulfate. In another embodiment, the surfactant is a mixture of at least two anionic surfactants. In one embodiment, the surfactant comprises a mixture of an alkyl benzene sulfonate and an alkyl-ether sulfate. In another embodiment, and the alkyl-ether sulfate is sodium lauryl ether sulphate (SLES). In certain preferred embodiments, the detergent is free of SLS and/or SLES.

In another embodiment, the anionic surfactant is alkyl benzene sulfonic acid, methyl ester sulfate, sodium lauryl ether sulfate, or mixtures thereof. In another embodiment, the nonionic surfactant is alcohol ethoxylate, methyl ester ethoxylate, or mixtures thereof.

In an embodiment, the unit dose detergent composition includes an alkyl-ether sulfate, a linear alkylbenze sulfonate, and a fatty alcohol ethoxylate. These three materials may collectively make up no less than 30% of the formulation.

In certain embodiments, the surfactant comprises about 15 wt. % to about 30 wt. % of an anionic surfactant selected from the group consisting of alkyl benzene sulfonate, methyl ester sulfonate, sodium lauryl ether sulphate, and mixtures thereof, and about 15 wt. % to about 30 wt. % of a nonionic surfactant selected from the group consisting of alcohol ethoxylate, methyl ester ethoxylate, and mixtures thereof. Surfactants may collectively total more than 30 wt. % of the formulation. Surfactants are often the base of detergent compositions, however, other components, such as solvents and humectants may be used to make a liquid formulation rather than a solid formulation.

In an embodiment, fatty alcohol ethoxylate may make up about 5 wt. % to about 40 wt. %, preferably about 10 wt. % to about 24 wt. %, and more preferably about 12 wt. % to about 20 wt. % of the detergent composition. A linear alkyl benzene sulfonate may make up about 1 wt. % to about 12 wt. %, preferably about 2 wt. % to about 8 wt. %, and most preferably, about 4 wt. % to about 6 wt. % of the detergent composition. In some preferred embodiments, the alkyl-ether sulfate, the linear alkyl benzene sulfonate, and the fatty alcohol ethoxylate may be present in a ratio of (2 to 5):1:(3 to 10); preferably in a ratio of (2.5 to 3.5):1:(4 to 6); and most preferably in a ratio of approximately 3:1:5.

### Other Ingredients

The unit dose detergent compositions of the present invention may optionally comprise other ingredients that can typically be present in detergent products and/or personal care products to provide further benefits in terms of cleaning power, solubilization, appearance, fragrance, etc. Different groups of such materials are described below.

For example, non-aqueous solvents that may be included in the detergent composition are polyethylene glycol, glycerol, propylene glycol, ethylene glycol, ethanol, and 4C+ compounds. The term “4C+ compound” refers to one or more of: polypropylene glycol; polyethylene glycol esters such as polyethylene glycol stearate, propylene glycol laurate, and/or propylene glycol palmitate; methyl ester ethoxylate; diethylene glycol; dipropylene glycol; sorbitol; tetrarnethylene glycol; butylene glycol; pentanediol; hexylene glycol; heptylene glycol; octylene glycol; 2-methyl, 1,3 propanediol; xylitol; mannitol; erythritol; dulcitol; inositol; adonitol; triethylene glycol; polypropylene glycol; glycol ethers, such as ethylene glycol monobutyl ether, diethylene glycol monobutyl ether, triethylene glycol monobutyl ether, ethylene glycol monopropyl ether, diethylene glycol monoethyl ether, triethylene glycol monoethyl ether, diethylene glycol monomethyl ether, and triethylene glycol monomethyl ether; tris (2-hydroxyethyl)methyl ammonium methylsulfate; ethylene oxide/propylene oxide copolymers with a number average molecular weight of 3,500 Daltons or less; and ethoxylated fatty acids. These optional non-aqueous solvents may be included in amounts, individually, of anywhere from about 1 weight percent to about 30 weight percent.

Humectants: A humectant, for purposes of the present invention, is a substance that exhibits high affinity for water, especially attracting water for moisturization and solubilization purposes. The water is absorbed into the humectant; not merely adsorbed at a surface layer. The water absorbed by the humectant is available to the system; the water is not too tightly bound to the humectant. For example, in a skin lotion, the humectant attracts moisture from the surrounding atmosphere while reducing transepidermal water loss, and makes the water available to the skin barrier. Similarly, the humectant in a single dose liquid formula will not trap all the water needed for solubilization of other formula components—it will help to maintain the water balance between the formula, the film, and the atmosphere. Humectants possess hydrophilic groups which form hydrogen bonds with water. Common hydrophilic groups include hydroxyl, carboxyl, ester, and amine functionalities. A humectant can thus act as a solubilizer and moisture regulator in a unit dose formulation. Useful humectants include but not limited to polyols.

The polyol (or polyhydric alcohol) may be a linear or branched alcohol with two or more hydroxyl groups. Thus, diols with two hydroxyl groups attached to separate carbon atoms in an aliphatic chain may also be used. The polyol typically includes less than 9 carbon atoms, such as 9, 8, 7, 6, 5, 4, 3, or 2 carbon atoms. Preferably, the polyol includes 3 to 8 carbon atoms. More preferably, the polyol includes 3 to 6 carbon atoms. The molecular weight is typically less than 500 g/mol, such as less than 400 g/mol or less than 300 g/mol.

Embodiments of suitable polyols include, but not limited to: propylene glycol, butylene glycol, pentylene glycol, hexylene glycol, heptylene glycol, octylene glycol, 2-methyl-1,3-propanediol, xylitol, sorbitol, mannitol, diethylene glycol, triethylene glycol, glycerol, glycerin, erythritol, dulcitol, inositol, and adonitol.

The unit dose detergent compositions of the present invention may contain about 5 wt. % to about 75 wt. % of one or more humectants, preferably about 7 wt. % to about 50 wt. %, more preferably about 10 wt. % to about 40 wt. %. In one preferred embodiment, the liquid composition comprises 10 to 30 wt. %, of one or more C₂ to C₅ polyols. Preferably, the C₂ to C₅ polyols comprise a mixture of glycerin and propylene glycol, where the ratio of glycerin to propylene glycol is from 2:1 to 1:2. The liquid composition may be substantially free of monoalcohols, for example, the composition may comprise less than 1 wt. % of monoalcohols.

Water: Water functions as a solvent and viscosity modifier. Water is typically about 30 to about 70% by weight of the compositions.

Builders: Other suitable components include organic or inorganic detergency builders. Examples of water-soluble inorganic builders that can be used, either alone or in combination with themselves or with organic alkaline sequestrant builder salts, are glycine, alkyl and alkenyl succinates, alkali metal carbonates, alkali metal bicarbonates, phosphates, polyphosphates and silicates. Specific examples of such salts are sodium tripolyphosphate, sodium carbonate, potassium carbonate, sodium bicarbonate, potassium bicarbonate, sodium pyrophosphate and potassium pyrophosphate. Examples of organic builder salts that can be used alone, or in combination with each other, or with the preceding inorganic alkaline builder salts, are alkali metal polycarboxylates, water-soluble citrates such as sodium and potassium citrate, sodium and potassium tartrate, sodium and potassium ethylenediaminetetracetate (EDTA), sodium and potassium N(2-hydroxyethyl)-nitrilo triacetates, sodium and potassium N-(2-hydroxyethyl)-nitrilo diacetates, sodium and potassium oxydisuccinates, and sodium and potassium tartrate mono- and di-succinates, such as those described in U.S. Pat. No. 4,663,071, the disclosure of which is incorporated herein by reference.

Complexer/Chelator: Complexer and chelators help washing liquids support higher amounts of soils and/or metal ions. Complexer and/or chelators may functionally overlap with builders as discussed above. These are often poly carboxylic acids and/or salts thereof. Polyamines also may be used in this role. Suitable examples include iminodisuccinic acid, succinic acid, citric acid, ethylenediaminetetraacetic acid, etc. A complexer and/or chelator may make up about 0 to about 5 wt. % of the formulation, preferably about 0.1 to about 3 wt. % of the formulation, and most preferably about 0.5 to about 2 wt. % of the detergent composition.

Enzymes: Suitable enzymes include those known in the art, such as amylolytic, proteolytic, cellulolytic or lipolytic type, and those listed in U.S. Pat. No. 5,958,864, the disclosure of which is incorporated herein by reference. One protease is a subtillase from Bacillus lentus. Other suitable enzymes include proteases, amylases, lipases and cellulases. Additional enzymes of these classes suitable for use in accordance with the present invention will be wed-known to those of ordinary skill in the art and are available from a variety of commercial suppliers. Enzymes maybe provided with other components, including stabilizers. In an embodiment, the enzyme material may be approximately 10% by weight of active enzymes. The detergent composition may include about 0.25 to about 10 wt. %, preferably, 0.5 to 5.0 wt. %, and most preferably, about 1.0 to about 3.0 wt. % of active enzymes.

In certain embodiments, the enzyme can comprise (i) at least one protease in an amount of 0.01 to 0.3 wt. % relative to the total weight of the composition; (ii) at least one amylase in an amount of 0.2 to 1,0 wt. % relative to the total weight of the composition; and (iii) at least one mannanase in an amount of 0.2 to 1.0 wt. % relative to the total weight of the composition.

Foam Stabilizers: Foam stabilizing agents include, but not limited to, a polyalkoxylated alkanolamide, amide, amine oxide, betaine, sultaine, C₅-C₁₈fatty alcohols, and those disclosed in U.S. Pat, No. 5,616,781, the disclosure of which is incorporated by reference herein. Foam stabilizing agents are used, for example, in amounts of about 1 wt. % to about 20 wt. %, and typically about 3, wt. % to about 5 wt. %. The composition can further include an auxiliary foam stabilizing surfactant, such as a fatty acid amide surfactant. Suitable fatty acid amides are C₈-C₂₀ alkanol amides, monoethanolamides, diethanolamides, and isopropanolamides,

Colorants: In some embodiments, the liquid composition does not contain a colorant. In some embodiments, the liquid composition contains one or more colorants. The colorant(s) can be, for example, polymers. The colorant(s) can be, for example, dyes. The colorant(s) can be, for example, water-soluble polymeric colorants. The colorant(s) can be, for example, water-soluble dyes. The colorant(s) can be, for example, colorants that are well-known in the art or commercially available from dye or chemical manufacturers. The color of the colorant(s) is not limited, and can be, for example, red, orange, yellow, blue, indigo, violet, or any combination thereof.

The colorant may provide a secondary indicator of source for a user. The colorant may provide aesthetic or informational value. For example, the color of the detergent composition may be used to indicate a preferred water temperature (e.g., red for hot, blue for cold).

The total amount of the one or more colorant(s) that can be contained in the liquid composition, for example, can range from about 0.00001 wt. % to about 0.099 wt. %. The total amount of colorant(s) in the liquid composition can be, for example, about 0.0001 wt. %, about 0.001 wt. %, about 0.01 wt. %, about 0.05 wt. %, or about 0.08 wt. %.

Colorant Stabilizer(s): In some embodiments, the liquid composition can optionally contain a colorant stabilizer. In some embodiments, the colorant stabilizer can be citric acid. The total amount of the optionally present colorant stabilizer(s) in the liquid composition can range, for example, from about 0,01 wt. % to about 5.0 wt. %. The total amount of the colorant stabilizer(s) in the liquid composition can be, for example, about 0.1 wt. %, about 1 wt. % about 2 wt. %, about 3 wt. %, or about 4 wt. %.

Optical Brightener/Whitening Agents: Optical brighteners and/or whitening agents help washed material appear white, especially under florescent light. The particular whitening agent is not believed to be impactful to the shelf stability of the formulations, Whitening agents may be complex, polycyclic molecules. Examples of whitening agents include: 4,4′-diamino-2,2′-stilbenedisulfonic acid and 2,5-bis(benzoxazol-2-yl)thiophene. The substitution of similar whitening agents and/or reasonable modifications of their concentration in the formulation should produce similar results, An optical brightener and/or whitening agent may make up about 0 to about 5 wt. % of the formulation, preferably about 0.1 to about 3 wt. % of the formulation, and most preferably about 0.2 to about 2 wt. % of the detergent composition.

Bittering Agent: Bittering agents may optionally be added to hinder accidental ingestion of the composition. Bittering agents are compositions that taste bad, so children and/or others are discouraged from accidental ingestion. Exemplary bittering agents include denatonium benzoate, aloin, and others. Bittering agents may be present in the composition at an amount of from about 0 to about 1 wt. %, preferably from about 0 to about 0.5 wt. %, and most preferably from about 0 to about 0.1 wt. %, based on the total weight of the detergent composition.

Perfumes: The liquid compositions of the invention may optionally include one or more perfumes or fragrances. As used herein, the term “perfume” is used in its ordinary sense to refer to and include any fragrant substance or mixture of substances including natural (obtained by extraction of flowers, herbs, leaves, roots, barks, wood, blossoms or plants), artificial (mixture of natural oils or oil constituents) and synthetically produced odoriferous substances. Typically, perfumes are complex mixtures of blends of various organic compounds such as alcohols, aldehydes, ethers, aromatic compounds and varying amounts of essential oils (e.g., terpenes) such as from 0 wt. % to 80 wt. %, usually from 1 wt. % to 70 wt. %, the essential oils themselves being volatile odoriferous compounds and also serving to dissolve the other components of the perfume. Perfumes can be present from about 0.1 wt. % to about 10 wt. %, and preferably from about 0.5 wt. % to about 5 wt. % of the detergent composition.

Other Optional Ingredients: The liquid compositions may also contain one or more optional ingredients conventionally included in detergent compositions such as a pH buffering agent, a perfume carrier, a fluorescer, a polyelectrolyte, a pearlescer, an anti-shrinking agent, an anti-wrinkle agent, an anti-spotting agent, an anti-corrosion agent, a drape imparting agent, an anti-static agent, an ironing aids crystal growth inhibitor, an anti-oxidant, an anti-reducing agent, a dispersing agent, a fragrance component, a bleaching catalyst, a bleaching agent, a bleach activator, an anticorrosion agent, a deodorizing agent, a color/texture rejuvenating agent, a preservative, and a mixture thereof. Examples and sources of suitable such components are well-known in the art and/or are described herein.

### Methods of Use

The fabrics and/or garments subjected to a washing, cleaning or textile care processes contemplated herein may be conventional washable laundry, such as household laundry, In some embodiments, the major part of the laundry is garments and fabrics, including but not limited to knits, woven fabrics, denims, non-woven fabrics, felts, yarns, and toweling. The fabrics may be cellulose based such as natural cellulosics, including cotton, flax, linen, jute, ramie, sisal or coir or manmade cellulosics (e,g,, originating from wood pulp) including viscose/rayon, ramie, cellulose acetate fibers (tricell), lyocell or blends thereof. The fabrics may also be non-cellulose based such as natural polyamides including wool, camel, cashmere, mohair, rabbit, and silk, or the fabric may be a synthetic polymer such as nylon, aramid, polyester, acrylic, polypropylene and spandex/elastin, or blends of any of the above-mentioned products. Examples of blends are blends of cotton and/or rayon/viscose with one or more companion material such as wool, synthetic fibers (e.g., polyamide fibers, acrylic fibers, polyester fibers, polyvinyl alcohol fibers, polyvinyl chloride fibers, polyurethane fibers, polyurea fibers, aramid fibers), and cellulose-containing fibers (e.g., rayon/viscose, ramie, flax, linen, jute, cellulose acetate fibers, lyocell).

In one embodiment, the fabrics and/or garments are added to a washing machine, and the detergent is also added to the washing machine before wash water is added. In an alternate embodiment, the detergent may be added to an automatic detergent addition system of a washing machine, where the contents are added to the wash water with the fabrics and/or garments after the washing process has begun. In yet another embodiment, the detergent is manually added to the fabrics and/or garments with the wash water after the washing process has started. The fabrics and/or garments are laundered with the wash water and the contents of the detergent. The fabrics and/or garments may then be dried and processed as normal.

Fabrics washed in the foregoing manner exhibit stain removal performance, Stain removal capability of compositions described herein can be evaluated in accordance with ASTM D4265 -14, the contents of which are incorporated herein by reference.

A method for finishing textiles using a soil-release protective layer is also described according to the invention, which method comprises the following method steps:
a. providing a detergent composition containing soil release polymer as described above, and
b. bringing a textile into contact with the detergent composition.

For this purpose, the detergent composition product can be prepared in the form of a solution (wash liquor) to facilitate contact with the textile. By using or carrying out the method according to the invention, the textiles treated according to the invention are provided with a kind of dirt-repellent protective layer, which effectively reduces or even prevents soiling and facilitates and thus improves the removal of soiling or re-soiling absorbed by the textile.

It is assumed that, using the method, soiling is prevented from penetrating the textiles and at most remains on the surface thereof, and in particular on the protective layer or the protective film thereon. The soiling can be removed very easily from said surface, for example by being separated with part of the protective layer or also with the entire protective layer, and in particular by being washed out. Washing out is promoted in particular by the hydrophilic content of the soil release polymer. The method is simple, can be implemented without great technical effort, and protects the treated textiles from staining. The advantageous effects are achieved for different types of textiles (for example cotton-based textiles, polyimide-based textiles, polyester-based textiles and any type of blended fabric) as well as for different forms of soiling (hydrophilic and hydrophobic soiling).

A further aspect of the present invention also describes the use of a detergent composition containing soil release polymer as disclosed above for reducing re-soiling of textiles and improving the removal of soiling from textiles. These effects are achieved for different types of textiles (for example cotton-based textiles, polyimide-based textiles, polyester-based textiles and blended fabrics) and different forms of soiling as a result of the detergent composition delivering the soil release polymer that is present in the composition according to the invention.

### EXAMPLES

### Example 1

The following formulations 1-4 are exemplary of those within the scope of the present disclosure.

| | Material | | | | |
|---|---|---|---|---|---|
| | Activity | Formula 1 | Formula 2 | Formula 3 | Formula 4 |
| Component | % | wt. % | wt. % | wt. % | wt. % |
| Polyethyleneimine | 80 | 1 to 3 | 1 to 3 | 0.5 to 5.0 | 0.5 to 5.0 |
| Ethoxylate | | | | | |
| Soil Release Polymer | 60.5 | 0.5 to 3 | 0.5 to 3 | 0.1 to 5.0 | 0.1 to 5.0 |
| TEXCARE SRN260 | | | | | |
| Triethanolamine | 85 | 0.40 to 1.00 | 0.40 to 1.00 | 0.2 to 2.0 | 0.2 to 2.0 |
| Hydrophonically | 37 | 1.5 to 2.5 | 1.5 to 2.5 | 1.0 to 4.0 | 1.0 to 4.0 |
| modified | | | | | |
| acrylate/styrene | | | | | |
| copolymer | | | | | |
| Alcohol Ethoxysulfate | 60 | 12 to 20 | 12 to 20 | 10 to 24 | 10 to 24 |
| Surfactant (e.g., 25-3) | | | | | |
| Alcohol Ethoxylate | 100 | 12 to 20 | 12 to 20 | 10 to 24 | 10 to 24 |
| (e.g., C₁₂-C₁₅ Alcohol | | | | | |
| Ethoxylate 7EO) | | | | | |
| Coconut Oil Fatty Acid | 100 | 1 to 2 | 1 to 2 | 0.5 to 3.5 | 0.5 to 3.5 |
| 2-Phenyl Sulfonic Acid | 96 | 1 to 8 | 1 to 8 | 1.0 to 12.0 | 1.0 to 12.0 |
| (LAS) | | | | | |
| Alkanolamine | 96 | 0.5 to 1.5 | 0.5 to 1.5 | 0.1 to 2.0 | 0.1 to 2.0 |
| (e.g., | | | | | |
| Monoethanolamine) | | | | | |
| Enzymes | 10 | 1.5 to 3.5 | 1.5 to 3.5 | 0.5 to 5.0 | 0.5 to 5.0 |
| Fragrance | 100 | 0.5 to 1.5 | — | 0.5 to 3.0 | — |
| Chelant | 33 | 1.5 to 4.0 | 1.5 to 4.0 | 0.5 to 5.0 | 0.5 to 5.0 |
| Optical Brightener | 100 | 0.15 to 0.75 | 0.15 to 0.75 | 0.1 to 1.0 | 0.1 to 1.0 |
| Colorant | 100 | 0.005 to 0.015 | — | 0.001 to 0.030 | — |
| Misc. | | 3.5 to 9.5 | 3.5 to 9.5 | 3 to 10 | 3 to 10 |
| Water | 100 | q.s. | q.s. | q.s. | q.s. |
| Total Formulation | | 100 | 100 | 100 | 100 |

### Example 2

Detergents free of colorant and fragrance (FC) were prepared using standard methods to assess the effect of SRP at various levels (0%, 0.5%, 1.5%). The compositions contained 3,9% by weight active LAS, 15.0% by weight active AES, and 15.3% by weight alcohol ethoxylate nonionic surfactant and did not contain any added propylene glycol. The SRP was TEXCARE SRN260. P1 was a control containing no SRP, P2 contained 0.5% SRP, and P3 contained 1.5% SRP.

| | % | wt % in |
|---|---|---|
| Description | Activity | Formula |
| Water | 100 | qs |
| Citric Acid | 50 | 3.5 |
| Caustic Soda | 50 | 2.0 |
| Triethanolamine USP 99% | 85 | 1.0 |
| Monoethanolamine | 100 | 0.7 |
| Alkylbenzenesulfonic Acid Low 2-Phe | 96 | 4.1 |
| Coconut Oil Fatty Acid | 100 | 1.1 |
| Calcium Chioride | 95 | 0.1 |
| Optical Brightener | 91 | 0.3 |
| Alcohol ethoxylate 7EO | 100 | 15.3 |
| C12-15 AES C12-15 3 Ethoxysulfate | 60 | 15.0 |
| Ethoxylated Aziridine homopolymer | 80 | 1.3 |
| Acrylic/styrene copolymer | 37 | 1.7 |
| Iminodisuccinic Acid-Sodium Salt Sol. | 34 | 2.9 |
| Preservative | 100 | 0.2 |
| Enzyme | 100 | 2.5 |
| Soil Release Polymer | 100 | 0-1.5 |
| Subtotal | | 100.000 |

### Example 3

### Evaluation of Permasthik

730 Polyester swatches were pre-washed three times consecutively with a 41.33 gram dose of a composition of Example 2 (P1 (0% SRP), P2 (0.5% SRP), or P3 (1.5% SRP)) in a HE Top Loader (59° F., Normal cycle, with no ballast) followed by a 20 minute dry on low setting after the third wash. Once dried, the swatches were treated with permastink malodor (SBO/sebum with ethanol/heptane carrier). The malodor-treated swatches were washed with a 41.33 gram dose of the compositions being tested (P1 to P3 respectively) in a HE Top Loader (59° F., Normal cycle, with a 100% cotton ballast to bring the load to 6 lbs.) and subsequently dried for 60 min at low setting with a 100% cotton ballast to bring load to 6 lbs. After drying, the permastink malodor was applied again to begin the second cycle. This process continued until 5 cycles of malodor application, followed by wash with P1-P3, and dry were completed. After the fifth cycle, the swatches were then re-wetted and put in odor sampling bags to generate headspace. The bags were kept in a temperature controlled static dryer at 105° F. for one hour. The generated headspace was then evaluated using odor sampling bags. Swatches were assessed randomly and scored on a 0-10 intensity scale for permastink malodor.

Statistical analysis of 8 samples was run using a commercially available statistical software program and the following values were obtained. The mean score is shown below.

| Product | Description | Matodor Score |
|---|---|---|
| P1 | Free Clear (FC) | 4.38 |
| P2 | FC + 0.5% SRP | 3.75 |
| P3 | FC + 1.5% SRP | 2.69 |

The Free Clear composition containing 1.5% SRP yielded significantly weaker (i.e., a resilient) permastink malodor (2,69 malodor score) compared to that of the 0.5% SRP formula (3.75 malodor score) and the control (4,38 malodor score).

### Example 4

### Evaluation of Antiperspirant Residue

Literature indicates that aluminum zirconium tetrachlorohydrex gly ingredients cause or accelerate yellow underarm staining. Therefore, ICP analysis was run for Al, Zr and Si presence in polyester fabric samples pre-washed three times with various detergent compositions then subsequently treated with sweat and antipersperant, washed, and dried 6 times thereafter. AR2 detergent containing 0.75 wt. % active SRF was compared to commercial HDL and control formulation AR1 containing no SRP. The SRP was Clariant TEXCARE SRN 260.

Compositions

| | % | AR1 wt. % | AR2 wt, % |
|---|---|---|---|
| Ingredient | Activity | (Control) | (0.75% SRP) |
| DI Water | 100 | q.s. | q.s. |
| Citric Acid | 50 | 2.00 | 2.00 |
| NaOH | 50 | 1.15 | 1.15 |
| Triethanolamine | 85 | 1.00 | 1.00 |
| LAS | 96 | 4.09 | 4.09 |
| Coconut Oil Fatty Acid | 100 | 1.12 | 1.12 |
| Calcium Chloride | 95 | 0.05 | 0.05 |
| Optical Brightener | 91 | 0.23 | 0.23 |
| Alcohol Ethoxylate | 100 | 15.27 | 15.27 |
| 7EO | | | |
| AES | 60 | 14.97 | 14.97 |
| Polyethyleneimine | 80 | 1.25 | 1.25 |
| Acrylic/sytrene | 37 | 1.71 | 1.71 |
| copolymer | | | |
| Iminodisuccinic Acid | 34 | 2.94 | 2.94 |
| Monoethanolamine | 100 | 0.70 | 0.70 |
| Colorant | 100 | 0.01 | 0.01 |
| Fragrance | 100 | 1.00 | 1.00 |
| Preservative | 100 | 0.19 | 0.19 |
| Enzymes | 100 | 2.48 | 2.48 |
| SRP | 60 | 0 | 1.25 |

After pre-washing the fabrics with detergent formulas three times, 0.7 g synthetic sweat mixture (97-99% water, S:2.5% sodium chloride, s.0,05% histidine) was mixed with 0.7 g of OLD SPICE PURE SPORT antiperspirant stick and was then applied to the fabrics; the sample was air-dried for 30 minutes; the sample was washed with 0.64 of the respective detergent using a tergitometer; and dried on high heat for 40 minutes. This [treat, dry, wash, dry] cycle was performed 6 times and then the samples were analyzed.

For ICP analysis, the samples were prepared by microwave digestion in duplicate. Polyester fabric sample sizes of approximately 500 mg (weighed to the nearest 0.1 mg) were digested in 8 mL nitric acid using the following profile: ramping to 90° C. over 10 minutes and holding for 5 minutes, then ramping to 170° C. over 10 minutes and holding for 5 minutes, then ramping to 190° C. over 5 minutes and holding for 25 minutes. After cooling to room temperature, the samples were gravimetrically diluted in 2% nitric acid (to approximately 20 g final weight) and an internal standard was added prior to analysis by ICP. Quantification was achieved using a three-level calibration with linear regression. Duplicate nitric acid blanks (no fabric) were prepared in parallel the Al, Si, and Zr values of the blank were subtracted from the sample results.

Results

The average results of two individual preparations are reported below with concentrations in pg/mL (ppm),

| | Al | Si | Zr |
|---|---|---|---|
| Sample | (ppm) | (ppm) | (ppm) |
| AR1 (control) | 1,609 | 326 | 8,831 |
| AR2 (0.75% SRP) | 1,307 | 158 | 7,319 |
| Commercial HDL | 2,206 | 70 | 10,226 |

Fabrics pre-washed three times with a detergent containing 0.75% SRP contained less aluminum, zirconium, and silicon. It was concluded that the AR2 prewash created an SRP barrier that allowed the deodorant and underarm sweat mixture to be more easily dislodged by the detergent as compared to the control AR1 and the commercial HDL. Therefore, fabrics pre-washed with the inventive detergents are less likely to exhibit yellow underarm staining and/or will resist underarm discoloration longer than fabrics without a SRP barrier.

### Example 5

### Stain Removal

Stain removal capability of compositions was evaluated in a multi-wash study in accordance with ASTM D4265 -14. The stain removal benefit was measured using the stain removal index (SRI)—a larger SRI indicates greater soil release. The SRI was measured on various fabrics after wash cycle numbers 1, 3, 5, 7 and 10.

Compositions

| | | WS1 | WS2 |
|---|---|---|---|
| | % | wt. % | wt. % |
| Component | Activity | (Control) | (0.5% SRP) |
| DI Water | 100 | q.s. | q.s. |
| Citric Acid | 50 | 2.00 | 2.00 |
| NaOH | 50 | 1.15 | 1.15 |
| Triethanolamine | 85 | 0.59 | 0.59 |
| LAS | 95 | 4.09 | 4.09 |
| Coconut Oil Fatty Acid | 100 | 1.12 | 1.12 |
| Calcium Chloride | 100 | 0.05 | 0.05 |
| Optical Brightener | 22 | 0.37 | 0.37 |
| Alcohols C12-15, | 100 | 15.27 | 15.27 |
| ethoxylated | | | |
| AES | 60 | 14.97 | 14.97 |
| Polyethyleneimine | 80 | 1.25 | 1.25 |
| Acrylic/styrene copolymer | 37 | 1.70 | 1.71 |
| Iminodisuccinic Acid | 34 | 2.94 | 2.94 |
| Monoethanolamine | 100 | 0.70 | 0.70 |
| Colorant | 100 | 0.60 | 0.60 |
| Fragrance | 100 | 1.00 | 1.00 |
| Preservative | 100 | 1.00 | 0.92 |
| Enzymes | 100 | 2.48 | 2.48 |
| SRP | 60 | 0 | 0.83 |

SRP was Clariant TEXCARE SRN 260.

Washing

Three fabrics (Knitted Poly, Knitted Cotton, and Knitted Poly/Cotton Blend sheets) were prewashed in HE top loaders. The wash water was approximately 90° F. and a ballast composed of 50% cotton and 50% poly sheeting was utilized. 1 ppm chlorine was dosed in wash and rinse. Sheets were pulled after 1×, 3×, 5×, 7×, and 10× washes with a dry cycle in between each wash.

Prewashed sheets were then hand stained on the same dame with 4 different stains (dust sebum, beef drippings, HEINZ MAYOCUE, RAGU OLD WORLD STYLE Meat Sauce. Color readings were taken of stains before washing using a spectrophotometer according to ASTM guidelines.

Sheets for each wash timepoint were then washed all together in with various compositions in an HE top loader on normal wash cycle utilizing either 90° F. or 59° F. wash water and a ballast composed of 50% cotton and 50% poly sheeting. 1 ppm chlorine was dosed in wash and rinse. The fabrics were dried per standard ASTM conditions.

Color readings were taken of stains again after washing using a Spectrophotometer. ΔE and Stain Removal Index (SRI) was calculated for each stain according to ASTM D4265 guidelines.

An LS Means Tukey HSL statistical analysis was performed for each stain/fabric/temperature combination using statistical analysis software at 95% confidence.

Results

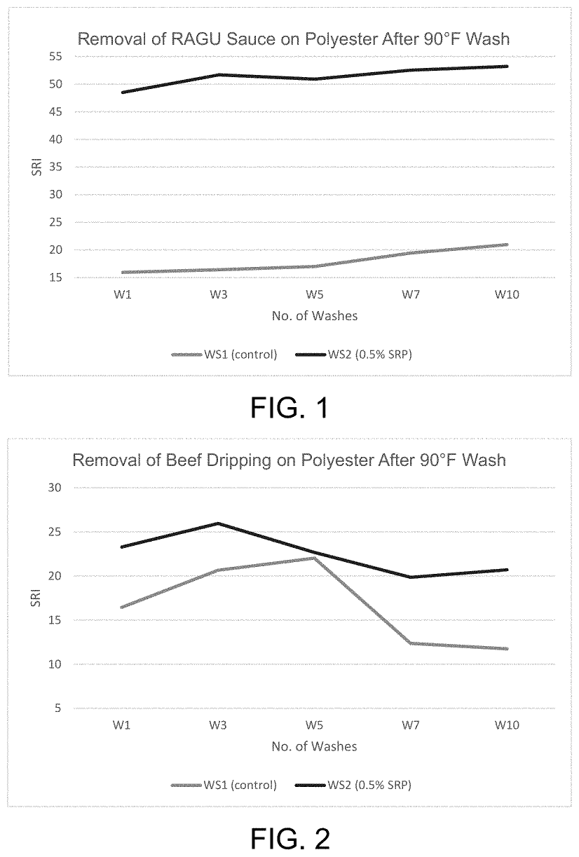

In FIG. 1, the bottom line shows the stain removal performance of a control formula while the top line shows the stain removal performance of an inventive formula containing 0.5% SRP on the RAGU sauce stains over 20 washes at 90° F. Even after the first wash (W1), the inventive formula demonstrates an obvious cleaning benefit compared to the benchmark. After three washes (W3), an optimal SRP barrier is formed.

In FIG. 2, the bottom line shows the stain removal performance of a control formula, while the top line shows the stain removal performance of an inventive formula containing 0.5% SRP on the beef drippings stains over 20 washes at 90° F. Even after the first wash (W1), the inventive formula demonstrates a significant cleaning benefit compared to the benchmark. After three washes (W3), the SRP barrier is further improved.

SRI of the inventive formula on various stains at cold and hot wash temperature showed similar performance.

| | | SRI of | SRI of |
|---|---|---|---|
| | | WS2 @ | WS2 @ |
| Stain | Washes | 59° F. | 90° F. |
| Beef Drippings | 1 | 3.89 | 6.84 |
| | 3 | 2.16 | 5.30 |
| | 5 | 5.07 | 0.65 |
| | 7 | 1.93 | 7.50 |
| | 10 | 1.74 | 8.97 |
| Dust Sebum | 1 | 4.03 | 5.42 |
| | 3 | 4.68 | 6.24 |
| | 5 | 4.34 | 6.06 |
| | 7 | 4.02 | 6.04 |
| | 10 | 3.62 | 5.27 |
| MAYOCUE | 1 | 5.04 | 6.82 |
| | 3 | 6.25 | 5.86 |
| | 5 | 5.34 | 5.73 |
| | 7 | 4.84 | 7.11 |
| | 10 | 4.84 | 4.84 |
| RAGU w/Meat | 1 | 30.48 | 32.55 |
| | 3 | 32.38 | 35.27 |
| | 5 | 30.38 | 33.91 |
| | 7 | 32.47 | 3309 |
| | 10 | 28.95 | 32.24 |

At 59° F., all data points except for beef drippings after 10 washes WS2 showed statistically better performance than the control formula WS1. At 90° F., all data points of WS2 except for beef drippings after 5 washes showed statistically better performance than the control formula WS1.

The inventive formula WS2 with the stain protection technology thus provides a statistically significant increase in performance across wash temperature compared to a benchmark formula that did not include SRP after just one wash. Such performance was consistent over a group of common tough-to-remove stains, throughout multiple washes regardless of whether the washes were conducted in warm water or cold water.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It should be understood that various changes may be made in the function and arrangement of elements described in an exemplary embodiment without departing from the scope of the subject matter as set forth in this application.

What is claimed is:

1. A stable liquid detergent composition comprising
about 0.25 to about 3% by weight of a polyester type soil release polymer (SRP) comprising aromatic dicarboxylic acids and alkylene glycols;
about 10 to about 30% by weight of an alcohol ethoxysulfate (AES) surfactant;
about 1 to about 12% linear alkyl benzene sulfonate (LAS) surfactant; and
about 12 to about 25% by weight of nonionic surfactant.

2. The detergent composition of claim 1, wherein the composition comprises less than 2.5% polyethylene glycol.

3. The detergent composition of claim 1, wherein the linear alkyl benzene sulfonate surfactant is sodium dodecylbenzene sulfonate:

4. The detergent composition of claim 1, wherein the composition contains about 15% by weight of the nonionic surfactant:

5. The detergent composition of claim 1, wherein the nonionic surfactant is an alkyl ether.

6. The detergent composition of claim 1, wherein the SRP has
(a) one or more nonionic hydrophilic components consisting essentially of
(i) polyoxyethylene segments having a polymerization level of at least 2 or
(ii) oxypropylene or polyoxypropylene segments having a polymerization level of 2 to 10, where the hydrophilic segment does not include any oxypropylene units, except when they are bonded via ether bonds to adjacent moieties at each end, or
(iii) a mixture of oxyalkylene units comprising oxyethylene units and 1 to about 30 oxypropylene units: and/or
(b) one or more hydrophobic components comprising
(i) C3-oxyalkylene terephthalate segments where, when hydrophobic components also include oxyethylene terephthalate, a ratio of oxyethylene terephthalate to C3-oxyalkylene terephthalate units is about 2:1 or less,
(ii) C4-C6-alkylene or oxy-C4-C6-alkylene segments or mixtures thereof,
(iii) poly(vinyl ester) segments, or
(iv) C1-C4-alkyl ether or 04-hydroxyalkyi ether substituents or mixtures thereof, where the substituents are C1-C4-alkyl ether or C4-hydroxyalkyl ether cellulose derivatives or mixtures thereof and the cellulose derivatives are amphiphilic.

7. The detergent composition of claim 6, wherein the polyoxyethylene segments of (a)(i) have a polymerization level of about 1 to about 200.

8. The detergent composition of claim 1, wherein the SRP is a polyester having repeat units formed from alkylene terephthalate units, containing 10%-30% by weight of alkylene terephthalate units together with 90%70% by weight of polyoxyethylene terephthalate units which derive from a polyoxyethylene glycol having a mean molecular weight of 300-8000.

9. The detergent composition of claim 1, further comprising about 0.5 to about 3.5% by weight of a fatty acid soap.

10. The detergent composition of claim 9, wherein the said fatty acid soap is selected from the group consisting of sodium salts of saturated C₁₄-C₁₈ carboxylic acids, sodium salts of unsaturated C₁₄-C₁₈carboxylic acids, potassium salts of saturated C₁₄-C₁₈ carboxylic acids, potassium salts of unsaturated C₁₄-C₁₈ carboxylic acids, and mixtures thereof.

11. The detergent composition of claim 1, comprising triethanolamine.

12. The detergent composition of claim 1, further comprising at least one enzyme selected from the group consisting of proteases, amylases, lipases, cellulases, mannanases, pectinases and combinations thereof, and wherein the composition preferably comprises 0.1 to 5 wt. % enzymes relative to the total weight of the composition.

13. The detergent composition of claim 12, wherein the enzyme comprises
(i) at least one protease in an amount of 0.01 to 0.3 wt.-% relative to the total weight of the composition;
(ii) at least one amylase in an amount of 0.2 to 1.0 wt.-% relative to the total weight of the composition; and
(iii) at least one mannanase in an amount of 0.2 to 1.0 wt.-% relative to the total weight of the composition.

14. A method of forming a protective barrier against stains on textiles comprising contacting the textiles with a washing liquor containing the detergent composition according to claim 1 in at least one step of a washing process.

15. The method according to claim 14, wherein the washing liquor is about 80° F. or less than 80° F.

16. The method of claim 14, wherein the washing liquor is less than 60° F.

17. The method of claim 14, wherein the step of contacting in at least one step of a washing process occurs at least three times.

18. A liquid detergent composition comprising
about 0.5 to about 1.5% by weight of a polyester soil releasing polymer having repeat units formed from alkylene terephthalate units, containing 10%-30% by weight of alkylene terephthalate units together with 90%-70% by weight of polyoxyethylene terephthalate units which derive from a polyoxyethylene glycol having a mean molecular weight of 300-8000;
about 10 to about 30% by weight of an alcohol ethoxysulfate (AES) surfactant;
about 1 to about 12% linear alkyl benzene sulfonate (LAS) surfactant; and
about 12 to about 25% by weight of an alcohol ethoxylate nonionic surfactant.

19. A method of forming a protective barrier against stains on textiles comprising contacting the textiles three or more times with a washing liquor containing the detergent composition according to claim 18 in at least one step of a washing process.
